(19) United States
(12) Patent Application Publication
(10) Pub. No.: US 2025/0221380 A1
(43) Pub. Date: Jul. 10, 2025

(54) CAGE FOR PETS

(71) Applicant: Weijie Xu, Zhejiang (CN)

(72) Inventor: Weijie Xu, Zhejiang (CN)

(21) Appl. No.: 19/091,006

(22) Filed: Mar. 26, 2025

Related U.S. Application Data
(63) Continuation-in-part of application No. 18/364,991, filed on Aug. 3, 2023.

(51) Int. Cl. A01K 1/03

(52) U.S. Cl. CPC A01K 1/032

(57) ABSTRACT

The present invention discloses a cage for pets, specifically including side panels, base plate, activity plate, top connector, middle connector, bottom connector, top support bar, lateral support bar, bottom support bar, connection, attachment block, support column and other components, which improves the support structure thereof to provide a stable support for the cage, and the easy-to-install cage is structurally stable and easy to dismantle, and can be horizontally unloaded or vertically stacked to provide a better utility and give the user a more enjoyable use experience.

### CROSS-REFERENCE TO RELATED APPLICATIONS

This application is a continuation in part of U.S. application Ser. No. 18/364,991 filed 3 Aug. 2023, the contents of which are hereby incorporated by reference. In case of conflict of the incorporation by reference and the disclosure provided directly herein with respect to terms, definitions, or reference or figure numbers, the present disclosure contemplates distinct embodiments directed to each.

### TECHNICAL FIELD

The present invention relates to the technical field of cages and, in particular, to a cage for pets.

### BACKGROUND

Most of the existing cages are made of a plastic grid structure, which is not easy to assemble and disassemble, and in the process of use, since the bolts bear most of the pressure, the cage is prone to deformation and loosening under the action of pressure for a long period of time, and the space of the existing cages is limited, so that the cages are not able to ensure the stability of the structure in the case of horizontal unloading and vertical stacking, and in the case of horizontal unloading or vertical stacking of the cages, if there is a problem in a certain part of the cages, the whole cages may be out of balance, which will result in the occurrence of a safety accident, and for this reason we propose a cage for pets to be used to solve the above-mentioned problems.

### SUMMARY

It is an object of the present invention to provide a cage for pets to solve the problems raised in the above background art.

In order to achieve the above objects, the present invention provides the following technical solution, a cage for pets, wherein it comprises: The cage body comprises: an attachment block assembly, the attachment block assembly comprising: first attachment block and second attachment block; said first attachment block and second attachment block are provided with side walls, the first attachment block comprising first top bulge and first bottom bulge, the first top bulge extending upwards and having a certain height and the first bottom bulge extending downwards and having a certain height; said second attachment block comprising second bottom bulge and at least one second top bulge, said second top bulge extending upwardly and having a certain height and said second bottom bulge extending downwardly and having a certain height; said first attachment block is provided with first connection hole in the centre and said second attachment block is provided with second connection hole in the centre.

Compared with the existing technology, the present invention has the following beneficial effects, the cage is easy to assemble and disassemble, and can be horizontally unloaded and vertically stacked to expand the number of cages used, the cage has a support bar, and the support bar is provided with support column which interacts with each other to make the structure of the cage more stable, and the cage components are easy to dismantle, which makes it easy to dismantle and install, and gives the user a better experience of use.

### BRIEF DESCRIPTION OF DRAWINGS

In order to explain the technical scheme of this application more clearly, the drawings needed in the implementation will be briefly introduced below. Obviously, the drawings described below are only some implementations of this application. For those skilled in the art, other drawings can be obtained according to these drawings without creative work.

FIG. 1 is an exploded schematic diagram of an embodiment of the present invention.

FIG. 2 is a three-dimensional view of the present invention I.

FIG. 3 is a three-dimensional view of the present invention II.

FIG. 4 is a schematic diagram of the structure of the present invention.

FIG. 5 is a schematic of bottom connector.

FIG. 6 is a schematic of middle connector.

FIG. 7 is a three-dimensional view of first attachment block.

FIG. 8 is a front view of first attachment block.

FIG. 9 is a three-dimensional view of a second connecting block.

FIG. 10 is a schematic diagram of a support bar I.

FIG. 11 is a schematic diagram of the support bar II.

In the figures: 1 [symbol] roof plate; 9 [symbol] top connecting rod; 10 [symbol] top support bar; 11 [symbol] second side panel; 12 [symbol] lockset; 13 [symbol] top connector; 14 [symbol] first lateral support bar; 15 [symbol] support column; 16 [symbol] first side panel; 17 [symbol] airflow orifice; 19 [symbol] central support bar; 20 [symbol] middle connector; 21 [symbol] bottom support bar; 22 [symbol] bottom connector; 23 [symbol] bottom connection rod; 24 [symbol] first attachment block; 25 [symbol] second attachment block; 26 [symbol] first activity plate; 27 [symbol] second activity plate; 28 [symbol] armrests; 30 [symbol] third side panel; 31 [symbol] second side support bar; 32 [symbol] third side support bar; 33 [symbol] base plate; 40 [symbol] fourth lateral support bar; 50 [symbol] fifth lateral support bar; 132 [symbol] first bulge; 201 [symbol] second bulge; 203 [symbol] bezel; 221 [symbol] thirdly bulge; 241 [symbol] first bottom bulge; 242 [symbol] first connection hole; 243 [symbol] first top bulge; 251 [symbol] second bottom bulge; 252 [symbol] second top bulge; 253 [symbol] second connection hole; 401 [symbol] hollow tube; 402 [symbol] slot.

### DESCRIPTION OF EMBODIMENTS

While various aspects and features of certain embodiments have been summarized above, the following detailed description illustrates a few exemplary embodiments in further detail to enable one skilled in the art to practice such embodiments. Reference will now be made in detail to embodiments of the inventive concept, examples of which are illustrated in the accompanying drawings. The accompanying drawings are not necessarily drawn to scale. The described examples are provided for illustrative purposes and are not intended to limit the scope of the invention. It should be understood, however, that persons having ordinary skill in the art may practice the inventive concept without these specific details.

It will be understood that, although the terms first, second, etc. may be used herein to describe various elements, these elements should not be limited by these terms. These terms are only used to distinguish one element from another. For example, a first attachment could be termed a second attachment, and, similarly, a second attachment could be termed a first attachment, without departing from the scope of the inventive concept.

It will be understood that when an element or layer is referred to as being “on,” “coupled to,” or “connected to” another element or layer, it can be directly on, directly coupled to or directly connected to the other element or layer, or intervening elements or layers may be present. In contrast, when an element is referred to as being “directly on,” “directly coupled to,” or “directly connected to” another element or layer, there are no intervening elements or layers present. Like numbers refer to like elements throughout. As used herein, the term “and/or” includes any and all combinations of one or more of the associated listed items.

As used in the description of the inventive concept and the appended claims, the singular forms “a,” “an,” and “the” are intended to include the plural forms as well, unless the context clearly indicates other.

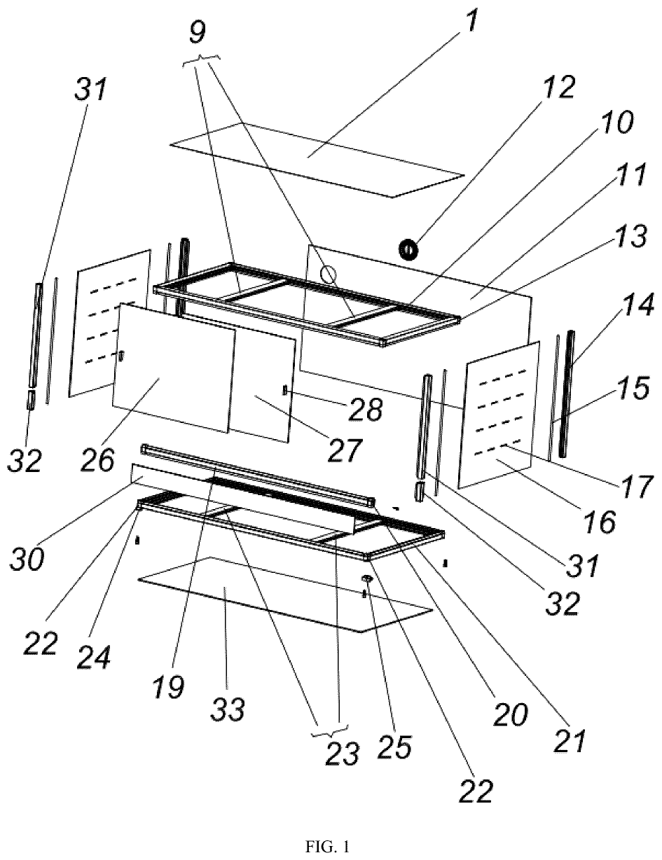

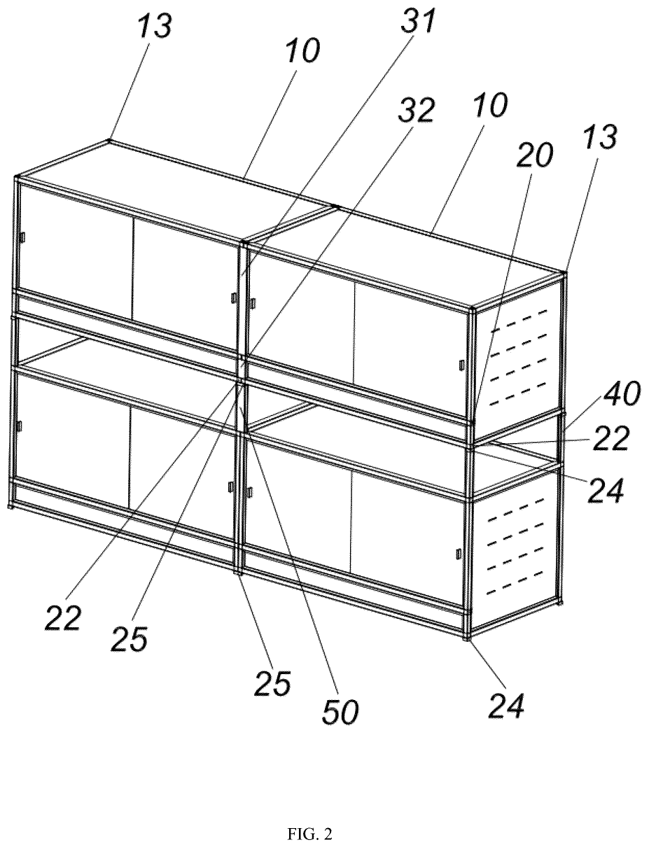

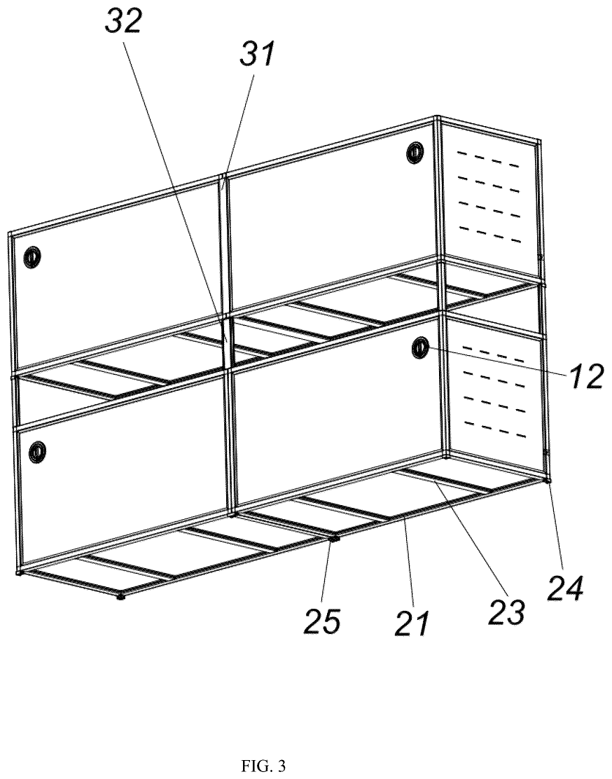

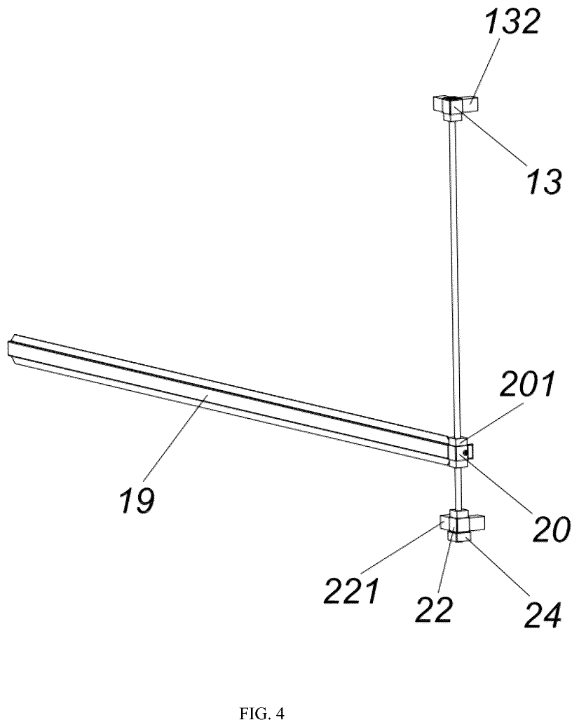

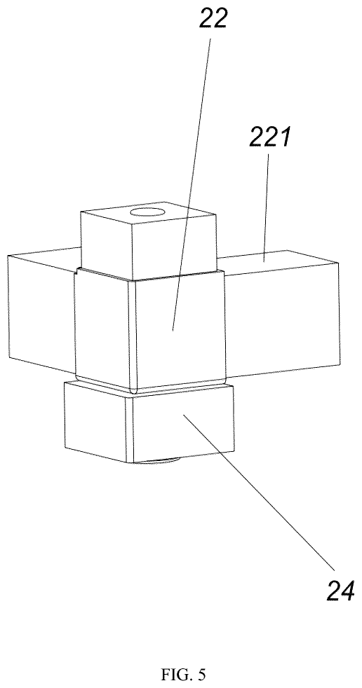

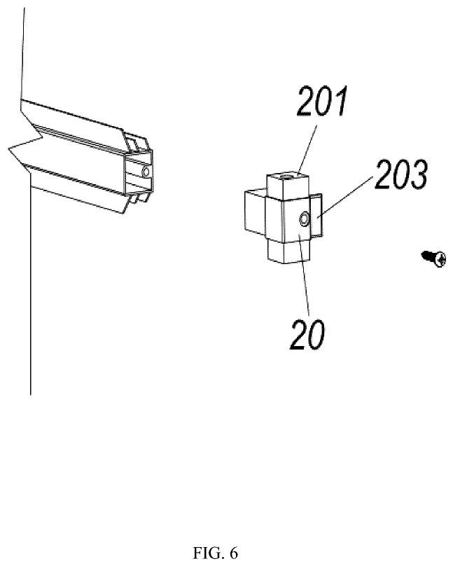

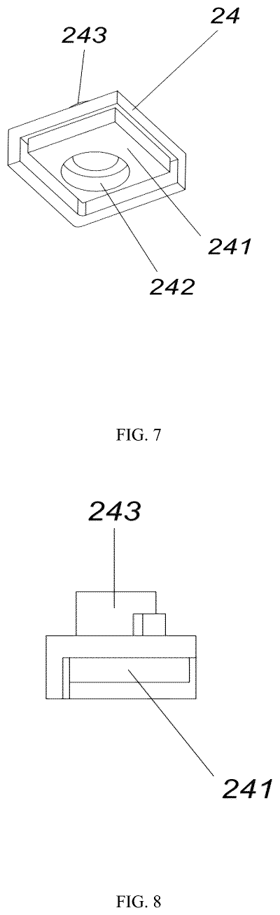

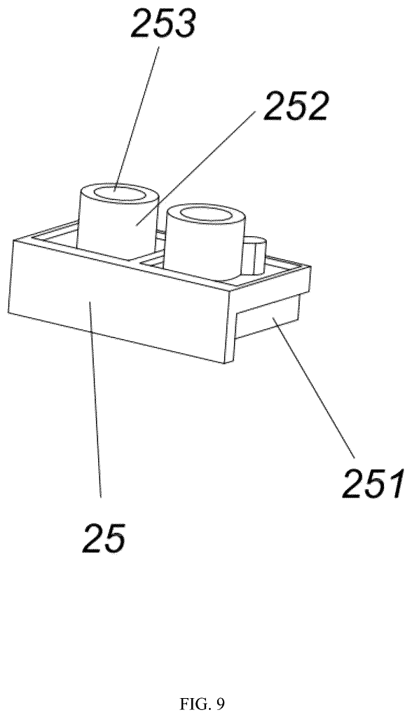

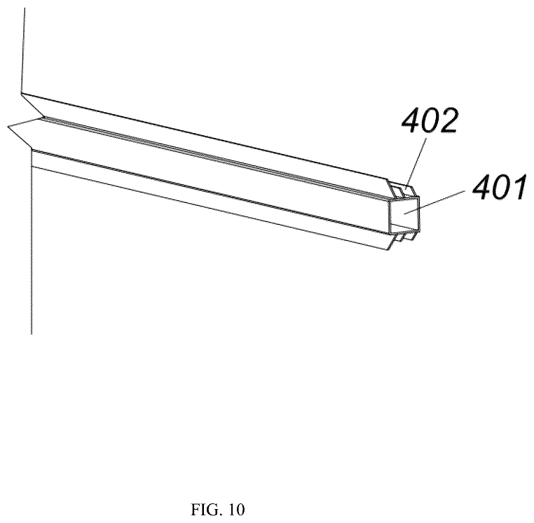

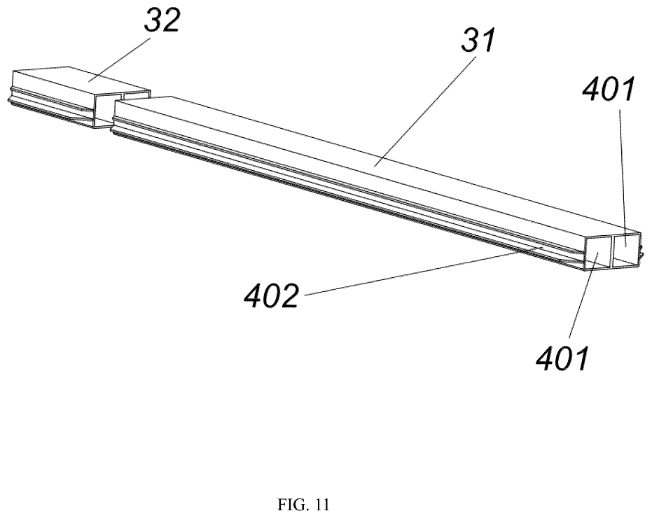

As shown in FIG. 1-FIG. 11, A cage with side panels, base plate, activity plate, top connector, middle connector, bottom connector, top support bar, lateral support bar, bottom support bar, connection, attachment block, support column, The side panels include first side panel 16, second side panel 11 and third side panel 30, with a number of lateral support bars connected to each end of first side panel 16, second side panel 11 and third side panel 30, the lateral support bars include first lateral support bar 14, second side support bar 31, third side support bar 32, fourth lateral support bar 40, fifth lateral support bar 50, with a number of top connector 13s connected to the tops of first lateral support bar 14 and second side support bar 31, and a number of middle connector 20s connected to the bottoms of second side support bar 31, with middle connector 20s connected to the bottoms of second side support bar 31 and the tops of third side support bar 32, respectively, between them, top connector 13 is connected between the ends of top support bar 10 respectively, and the ends of top connecting rod 9 are connected to top support bar 10, first lateral support bar 14, third side support bar 32 bottom connection bottom connector 22, bottom connector 22 are connected between the two ends of bottom support bar 21, respectively, and the two ends of bottom connection robase plate 3 are connected to bottom support bar 21, and after top connector 13 is completely inserted, top connector 13 is provided with notches on the bottom surface, bottom connector 22 is provided with notches on the top surface, and middle connector 20 is provided with through holes passing through the centre of middle connector 20, and then one end of support column 15 is fitted with the notches of top connector 13, and the other end of support column 15 passes through middle connector 20 and then is fitted with the notches of bottom connector 22, so that top connector 13, bottom connector 22 and middle connector 20 are fixedly connected to support column 15, and when support column 15 is inserted, top connector 13, bottom connector 22 and the other end of support column 15 is passed through middle connector 20 and then fitted with the notches of bottom connector 22, so that top connector 13, bottom connector 22 and middle connector 20 are fixedly connected to support column 15, and when the fixed installation of the four support column 15s is completed, the ends of first side panel 16, second side panel 11, third side panel 30 and first activity plate 26, second activity plate 27 are inserted into the lower end of the adjacent first lateral support bar 14, second side support bar 31 and the slot 402 of third side support bar 32, respectively.

Where in top connector 13 includes first bulge 132, threaded hole and notches, top support bar 10 includes hollow tube 401 and slot 402, hollow tube 401 is provided at the centre of top support bar 10 along the length of top support bar 10, slot 402 is provided on both sides of top support bar 10, and the two ends of first bulge 132 of top connector 13 are respectively inserted and connected to hollow tube 401 of top support bar 10 so as to make top connector 13 fit closely to top support bar 10, top connecting rod 9 includes first trident lock and first control knob, first trident lock is set at both ends of top connecting rod 9, first trident lock has movable first clamping arm on both sides, and first channel is provided on the side wall of top support bar 10, first control knob is hinged to first channel on top support bar 10, and by turning first control knob, first clamping arm on first trident lock can be both expanded and closed, so that top connecting rod 9 is closely connected to top support bar 10 and the stability of the connection is strengthened, so that top connecting rod 9, top support bar 10 and top connector 13 form a top frame. Top Frame, roof plate 1 snaps into slot 402 of top support bar 10 to close the top frame of the cage.

Where in bottom connector 22 includes thirdly bulge 221, threaded hole and notches, bottom support bar 21 includes hollow tube 401 and slot 402, hollow tube 401 of bottom support bar 21 is set in the centre of bottom support bar 21 throughout the longitudinal direction of the entire bottom support bar 21, slot 402 is set on both sides of bottom support bar 21, the two ends of thirdly bulge 221 of bottom connector 22 are respectively plugged in and out of bottom support bar 21 with hollow tube 401 of bottom support bar 21 so that bottom connector 22 is closely fitted to bottom support bar 21, bottom connection robase plate 3 includes thirdly bulge 221, threaded hole and notches both ends of thirdly bulge 221 of bottom connector 22 are plugged in and out of bottom support bar 21 with hollow tube 401 of bottom support bar 21, respectively, so that bottom connector 22 is closely fitted to bottom support bar 21, bottom connection robase plate 3 includes second trident lock and second control knob, second trident lock is provided at both ends of top connecting rod 9, both sides of second trident lock have second clamping arm which can be moved, second channel is provided on the side wall of bottom support bar 21, second control knob is hingedly connected to second channel on top support bar 10, and by rotating second control knob, second clamping arm on second trident lock can be both extended and retracted so that bottom connection robase plate 3 is closely connected to bottom support bar 21 to improve the stability of the connection and so that bottom connection rod 23, bottom support bar 21 and bottom connector 22 form a bottom frame, and base plate 33 snaps into slot 402 of bottom support bar 21 to close the bottom frame of the cage.

Where in middle connector 20 includes, second bulge 201, a through hole, bezel 203, central support bar 19 includes hollow tube 401, slot 402, and hollow tube 401 of central support bar 19 is plugged and connected to second bulge 201 of middle connector 20.

Where in lateral support bar comprises first lateral support bar 14, second side support bar 31, third side support bar 32, lateral support bar comprises hollow tube 401, slot 402, hollow tube 401 of lateral support bar is provided at the centre of lateral support bar through out the entire longitudinal direction of lateral support bar, slot 402 is provided on both sides of lateral support bar, one end of hollow tube 401 of lateral support bar is plugged and connected to second bulge 201 of middle connector 20, and the other end of hollow tube 401 of lateral support bar is plugged and connected to first bulge 132 of top connector 13 to form a side frame, and the first side panel 16 and the activity plate are snapped into the slot 402, and the other end of hollow tube 401 of lateral support bar is plugged and connected to first bulge 132 of top connector 13 to form a side frame, and first side panel 16 and activity plate are snapped into slot 402 of top support bar 10 to close the side frame of the cage.

Where in both sides of the cage are provided with first side panel 16, the upper end of first side panel 16 is snapped into slot 402 of top support bar 10, the lower end of first side panel 16 is snapped into slot 402 of bottom support bar 21, and both sides of first side panel 16 are snapped into slot 402 of lateral support bar, and first side panel 16 is provided with airflow orifice 17, so that the air can be flowed through airflow orifice 17, and so that the quality of the air inside the cage is at a better level.

Where in the upper end of second side panel 11 is snapped into slot 402 of top support bar 10, the lower end of second side panel 11 is snapped into slot 402 of bottom support bar 21, and both sides of second side panel 11 are snapped into slot 402 of first lateral support bar 14, and the top of second side panel 11 is opened with first through hole, and there is hingedly connected to lockset 12 in first through hole, and lockset 12 includes lockset body and knob, and the central position of lockset body is provided with second through hole, and knob can be rotated, when knob is in a locked state, knob is fixed to the lockset body, rotating knob, and when knob is in a locked state, knob can be rotated, and is hingedly connected to knob in second through hole, and knob is capable of being rotated, when knob is in a locked state, knob is fixed to the lockset body, thereby rotating knob, and when knob is in a free state, knob can be removed to facilitate subsequent interaction with the interior of the cage via second through hole, and in addition knob can be removed to ensure air circulation within the cage.

Where in the upper end of third side panel 30 is snapped into slot 402 of central support bar 19, the lower end of third side panel 30 is snapped into slot 402 of bottom support bar 21, and the sides of third side panel 30 are snapped into slot 402 of third side support bar 32.

Where in the bottom of top connector 13 is provided with notches, the top of bottom connector 22 is provided with notches, the middle position of middle connector 20 is provided with a through-hole, and the through-hole extends through the entire middle connector 20 from the top of middle connector 20, and middle connector 20 is provided with second bulge 201, and one end of support column 15 is snapped into notches of top connector 13, passes through the through hole of middle connector 20 and continues to extend downward and is finally snapped into notches of bottom connector 22, thereby reinforcing the strength of the cage as a whole and maintaining the overall structure of the cage in a stable condition.

Where in first attachment block 24 is provided with a side wall, said first attachment block 24 comprising first top bulge 243 and first bottom bulge 241, wherein first top bulge 243 extends upwardly and has a height specifically represented as a cylinder, and first bottom bulge 241 extends downwardly and has a height specifically represented as a square column, prism, etc., wherein first bottom bulge 241 is provided at the bottom of first attachment block 24, and wherein a socket is formed between the side wall of first attachment block 24 and the bottom projection of first attachment block 24, said socket being adjustable in size according to different usage scenarios, wherein first bottom bulge 241 is provided at the bottom of first attachment block 24, and wherein a socket is formed between the side wall of first attachment block 24 and the bottom projection of first attachment block 24, said socket being adjustable in size according to different use scenarios so as to facilitate clamping of side panels of different thicknesses, said first attachment block 24 being provided with first connection hole 242 at a central position, said first connection hole 242 extends from the bottom of attachment block to the top surface of the upper projection of first attachment block 24 throughout the entire height direction of said first attachment block 24, said first attachment block 24 first top bulge 243 is bolted to threaded hole of first attachment block 24 and the bolts pass through first connection hole 242 of first attachment block 24, thereby securing first attachment block 24 to bottom connector 22, and first attachment block 24 is detachably connected to bottom connector 22.

Where in, fourth lateral support bar 40 includes hollow tube 401, slot 402, and when a plurality of cages are required to be stacked for fit, fourth lateral support bar 40 is inserted into socket of first attachment block 24, and the other end of fourth lateral support bar 40 is connected to top connector 13 of the cage.

Where in, when the fifth lateral support bar 50 comprises hollow tube 401, slot 402, two hollow tube 401 are provided at the central position of the fifth lateral support bar 50, the hollow tube 401 are provided at the centre of the fifth lateral support bar 50 along the lengthwise direction of the fifth lateral support bar 50, one end of the two hollow tube 50s of the fifth lateral support bar 50 is fixedly connected to the bottom connector 22 of the cages, and the other end of the two hollow tube 401s of the fifth lateral support bar 50 is fixedly connected to the top connector 13 of the cages of the lower stacked cages, and by fixedly connecting the fourth lateral support bar 40s and the fifth lateral support bar 50 and the other end of the two hollow tube 401 of the fifth lateral support bar 50 is fixedly connected to the top connector 13 of the cages of the lower stacked cages, and by fixedly connecting the fourth lateral support bar 40 and fifth lateral support bar 50 to the connection or the attachment block it is possible to stack the cages up and down and further increase the number of cages and ensure the stability of the connection between the cages.

Where in second side support bar 31 and third side support bar 32 comprise hollow tube 401, slot 402, two hollow tube 401s are provided at the central position of second side support bar 31 and third side support bar 32, and slot 402 is provided at the side of second side support bar 31 and third side support bar 32, and when the cages are horizontally discharged, one end of hollow tube 401 of second side support bar 31 is plugged and unplugged with first bulge 132 of top connector 13 of the two cages the other end of hollow tube 401 of second side support bar 31 is plugged and unplugged with second bulge 201 of middle connector 20 plugged and unplugged, one end of hollow tube 401 of third side support bar 32 is plugged and unplugged with second bulge 201 of middle connector 20 of the two cages, and the other end of hollow tube 401 of third side support bar 32 is plugged and unplugged with thirdly bulge 221 of bottom connector 22.

Where in attachment block comprises first attachment block 24 and second attachment block 25, wherein second attachment block 25 comprises a side wall provided with second top bulge 252 and second bottom bulge 251 of said second attachment block 25, wherein second top bulge 252 extends upwardly and has a height specifically manifested as two cylinders, wherein a projection on the bottom surface of second attachment block 25 extends downwardly and has a certain height specifically manifested as two square columns, prisms, etc., and wherein the side wall of second attachment block 25 is formed between the side wall of second attachment block 25 and the second bottom bulge 251 of second attachment block 25 socket, and wherein the side wall of second attachment block 25 is formed between the side wall of second attachment block 25 and the second bottom bulge 251 of second attachment block 25 socket, the size of socket being adjustable according to different use scenarios so as to facilitate the clamping of side panels of different thicknesses, said second attachment block 25 being provided with two second connection hole 253 at the central position, and when the cages are assembled and disassembled horizontally, the bolts pass through the second connection hole 253 of the second attachment block 25 and are fixed to the bottom connector 22 of the two cages, so as to carry out the assembly and disassembly of the cages horizontally and to ensure the stability of the assembly of the cages.

Among them, the cage can be connected and disconnected in the horizontal direction, and it is also possible to realise the connection and stacking of multiple cages in the vertical direction, so as to realise the expansion of the cage in the horizontal direction and the vertical direction, which can satisfy different usage scenarios, and the components of the cage are easily assembled and disassembled, which is convenient for the user to reduce or increase the number of cages to be used, so as to give the user a better feeling of using the cages.

The technical means disclosed in the scheme of the present invention are not limited to the technical means disclosed in the above embodiments, but also include the technical scheme consisting of any combination of the above technical features. It should be noted that, for those skilled in the art, various improvements and embellishments can be made without departing from the principle of the present invention, and these improvements and embellishments are also considered to be within the scope of protection of the present invention.

The invention has now been described in detail for the purposes of clarity and understanding. However, those skilled in the art will appreciate that certain changes and modifications may be practiced within the scope of the appended claims.

What is claimed is:

1. A cage for pets, wherein it comprises:
a cage body;
The cage body comprises: an attachment block assembly, the attachment block assembly comprising: first attachment block and second attachment block;
Said first attachment block and second attachment block are provided with side walls, the first attachment block comprising first top bulge and first bottom bulge, the first top bulge extending upwards and having a certain height and the first bottom bulge extending downwards and having a certain height;
Said second attachment block comprising second bottom bulge and at least one second top bulge, said second top bulge extending upwardly and having a certain height and said second bottom bulge extending downwardly and having a certain height;
Said first attachment block is provided with first connection hole in the centre and said second attachment block is provided with second connection hole in the centre.

2. A cage for pets according to claim 1, wherein: said cage body further comprises an lateral support bar part, said lateral support bar part comprising, first lateral support bar, second side support bar, third side support bar, said first lateral support bar, second side support bar, third side support bar being provided with a hollow tube at a central position, said hollow tube running through the whole of the lengthwise direction of said first lateral support bar, said second side support bar, and said third side support bar, and said slot being provided at both sides of said first lateral support bar, second side support bar, third side support bar.

3. A cage for pets according to claim 2, wherein said cage body further comprises said support column, top connector, middle connector and bottom connector, said support column being set within said hollow tube, said top connector being provided with an notches on the bottom surface, said bottom connector having a notches on the top surface and said middle connector having a through hole in the middle of said middle connector provided with through hole through it, one end of said support column catching with the notches of said top connector and the other end of said support column passing through said middle connector and catching with the notches of said bottom connector, so that said top connector, said bottom connector and said middle connector are fixedly connected to said support column.

4. A cage for pets according to claim 1, wherein the cage body further comprises top support bar, said top support bar comprising hollow tube and slot, hollow tube being provided in the centre of top support bar throughout the entire length of top support bar, and slot being provided on both sides of top support bar.

5. A cage for pets according to claim 1, wherein the cage body further comprises bottom support bar, wherein bottom support bar comprises hollow tube and slot, hollow tube is provided in the centre of bottom support bar along the entire longitudinal direction of bottom support bar, and slot is provided on both sides of bottom support bar.

6. A cage for pets according to claim 4, wherein the cage body further comprises roof plate and base plate, the roof plate being snapped into the slot of the top support bar and the base plate being snapped into the slot of the bottom support bar.

7. A cage for pets according to claim 2, wherein the cage body further comprises first side panel, second side panel and third side panel, both sides of the first side panel being snapped between the first lateral support bar, third side support bar and second side support bar, the second side panel being snapped between the first lateral support bar and the third side panel being snapped between the third side support bar.

8. A cage for pets according to claim 4, wherein the cage body further comprises top connector, wherein the top connector comprises first bulge, threaded hole and notches, and the ends of the first bulge of the top connector are plugged and unplugged respectively to hollow tube of the top support bar to provide a tight fit between the top connector and the top support bar.

9. A cage for pets according to claim 4, wherein said cage body further comprises top connecting rod, said top connecting rod comprising top connecting rod body, first trident lock and first control knob, said first trident lock being provided at the ends of said top connecting rod, said first trident lock having movable first clamping arm on both sides, said top support bar having openings on the side walls, said first control knob being hingedly connected to said first channel on said top support bar, and by unscrewing said first control knob, said first clamping arm is unscrewed, said top support bar has openings on the side walls, said first control knob is hingedly coupled to said first channel on said top support bar, and by unscrewing said first control knob, said first clamping arm is expandable and retractable to tightly couple said top connecting rod to said top support bar.

10. A cage for pets according to claim 5, wherein said cage body further comprises bottom connection robase plate 3, said bottom connection robase plate 3 comprising bottom connection rod body, second trident lock and second control knob, said second trident lock being provided at the ends of said bottom connection robase plate 3, said second trident lock having movable second clamping arm on both sides, said bottom support bar having openings on the sidewalls thereof. Said second control knob is hinged to said second channel on said bottom support bar, and by twisting said second control knob, said second clamping arm can be expanded as well as retracted so that said bottom connection robase plate 3 is tightly connected to said bottom support bar.

11. A cage for pets according to claim 10, wherein said second clamping arm is made of metal.

12. A cage for pets according to claim 5, wherein the cage body further comprises bottom connector, the bottom connector comprising thirdly bulge, threaded hole and notches, the ends of the thirdly bulge of the bottom connector being plugged and unplugged respectively to the hollow tube of the bottom support bar so that the bottom connector fits closely to the bottom support bar.

13. A cage for pets according to claim 7, wherein the middle connector has a through hole second bulge, bezel, the hollow tube of the central support bar being inserted into the second bulge of the middle connector, and the bezel being capable of restricting the movement of the first side panel.

14. A cage for pets according to claim 2, wherein the cage body further comprises first activity plate, second activity plate, central support bar and top support bar, the first activity plate and the second activity plate being provided with armrests, the armrests being screwed to the first activity plate and the second activity plate, the first activity plate and the upper end of the second activity plate being seated in the slot of the top support bar, both sides of the first activity plate and the lower end of the second activity plate being seated in the slot of the central support bar, and the first activity plate and the lower end of the second activity plate are seated in the slot of the central support bar, and both sides of the first activity plate and the second activity plate are seated in the slot of the lateral support bar, and pulling on the armrests, the first activity plate and the second activity plate can move in the slot of the central support bar.

15. A cage for pets according to claim 7, wherein said first side panel is provided with said airflow orifice through which the air can flow.

16. A cage for pets according to claim 7, wherein said second side panel is provided with said first through hole at the top, said first through hole is hinged to said lockset, said lockset comprises lockset body and knob, said lockset body is provided with said second through hole at the central position, said second through hole is hinged to said knob, said knob can be rotated when said knob is in the locked state, said knob is fixed to said lockset body, said knob is rotated when said knob is in the free state, said knob can be rotated, said knob is fixed to said lockset body when said knob is in a locked state, said knob is rotated, and said knob is removed when said knob is in a free state to ensure air circulation within the cage.

17. A cage for pets according to claim 6, wherein said roof plate or base plate is provided with airflow orifice to ensure air circulation inside the cage.

18. A cage for pets, wherein it comprises:
Cage body;
The cage body comprises: an attachment block assembly, the attachment block assembly comprising: first attachment block and second attachment block;
The cage body comprises: an attachment block assembly, the attachment block assembly comprising: first attachment block and second attachment block;
Said first attachment block and second attachment block are provided with side walls, the first attachment block comprising first top bulge and first bottom bulge, the first top bulge extending upwards and having a certain height and the first bottom bulge extending downwards and having a certain height;
Said second attachment block comprising second bottom bulge and at least one second top bulge, said second top bulge extending upwardly and having a certain height and said second bottom bulge extending downwardly and having a certain height;
Said first attachment block is provided with first connection hole in the centre and said second attachment block is provided with second connection hole in the centre;
Said socket is formed between the side wall of the first attachment block and the first bottom projection of the first attachment block, and socket is formed between the side wall of the second attachment block and the side wall of the second attachment block and the second bottom bulge of the second attachment block;
The size of said socket can be adjusted according to different use scenarios to facilitate clamping of side panels of different thicknesses, said first attachment block is provided with said first connection hole in the centre of said first attachment block, the first connection hole runs from the bottom of the first attachment block to the top surface of the upper bulge of the first attachment block throughout the entire height direction of the first attachment block, and the first connection hole of the first attachment block is provided with a first connection hole and a bolt runs through the first connection hole to securely connect the bottom connector to the bottom connector, wherein the first top bulge of the first attachment block is plugged and unplugged from the threaded hole of the first attachment block and a pin passes through the first connection hole of the first attachment block to securely connect the first attachment block to the bottom connector, and the first attachment block is detachably connected to the bottom connector;
Said second attachment block is provided with at least one second connection hole at the centre of said second attachment block, and when the cages are connected and horizontally unloaded, the bolt passes through said second connection hole of said second attachment block and is fixedly connected to said bottom connector of the two cages, thereby achieving the horizontal connection and unloading of the cages and ensuring the stability of the cage connection.

19. A cage for pets according to claim 18, wherein said first attachment block and said second attachment block are made of wear-resistant metal material.

20. A method of using a cage for pets, wherein it comprises:
Cage body;
The cage body comprises: an attachment block assembly, the attachment block assembly comprising: first attachment block and second attachment block;
The cage body comprises: an attachment block assembly, the attachment block assembly comprising: first attachment block and second attachment block;
Said first attachment block and second attachment block are provided with side walls, the first attachment block comprising first top bulge and first bottom bulge, the first top bulge extending upwards and having a certain height and the first bottom bulge extending downwards and having a certain height;
Said second attachment block comprising second bottom bulge and at least one second top bulge, said second top bulge extending upwardly and having a certain height and said second bottom bulge extending downwardly and having a certain height;
Said first attachment block is provided with first connection hole in the centre and said second attachment block is provided with second connection hole in the centre;
Said socket is formed between the side wall of the first attachment block and the first bottom projection of the first attachment block, and socket is formed between the side wall of the second attachment block and the side wall of the second attachment block and the second bottom bulge of the second attachment block;
The size of said socket can be adjusted according to different use scenarios to facilitate clamping of side panels of different thicknesses, said first attachment block is provided with said first connection hole in the centre of said first attachment block, the first connection hole runs from the bottom of the first attachment block to the top surface of the upper bulge of the first attachment block throughout the entire height direction of the first attachment block, and the first connection hole of the first attachment block is provided with a first connection hole and a bolt runs through the first connection hole to securely connect the bottom connector to the bottom connector, wherein the first top bulge of the first attachment block is plugged and unplugged from the threaded hole of the first attachment block and a pin passes through the first connection hole of the first attachment block to securely connect the first attachment block to the bottom connector, and the first attachment block is detachably connected to the bottom connector;
Said second attachment block is provided with at least one second connection hole at the centre of said second attachment block, and when the cages are connected and horizontally unloaded, the bolt passes through said second connection hole of said second attachment block and is fixedly connected to said bottom connector of the two cages, thereby achieving the horizontal connection and unloading of the cages and ensuring the stability of the cage connection;
Said fourth lateral support bar, comprising hollow tube, slot, said hollow tube being provided in the centre of said fourth lateral support bar throughout the entire length of said fourth lateral support bar, and when a plurality of cages are stacked to fit together, said fourth lateral support bar is inserted into said socket of said first attachment block, and the other end of said fourth lateral support bar is connected to the cage's said top connector Connection;
Said fifth lateral support bar comprises hollow tube, slot, said fifth lateral support bar is provided with two hollow tube at a central position, said hollow tube is provided at the centre of said fifth lateral support bar throughout the length of said fifth lateral support bar, when a plurality of cages are horizontally discharged, one end of said two hollow tube of said fifth lateral support bar is fixedly connected to said bottom connector of said cages, and the other end of said two hollow tube of said fifth lateral support bar is fixedly connected to said bottom connector of said cages, and the other end of said two hollow tube of said fifth lateral support bar is fixedly connected to said bottom connector of said cages, and the other end of the hollow tube is fixedly connected to the bottom connector and the other end of the two hollow tube of the fifth lateral support bar is fixedly connected to the top connector of the lower stacked cages, and by fixedly connecting the fourth lateral support bar and the fifth lateral support bar to each other and to the connection and the attachment block, it is possible to stack the cages up and down to further increase the number of cages and to ensure the stability of the connection between the cages.
